(19) United States
(12) Patent Application Publication
(10) Pub. No.: US 2012/0003504 A1
(43) Pub. Date: Jan. 5, 2012

(54) MICROBIAL FUEL CELL AND MEMBRANE CASSETTE FOR MICROBIAL FUEL CELLS

(76) Inventors: Akira Yamazawa, Tokyo (JP); Yoshiyuki Ueno, Tokyo (JP); Masahiro Tatara, Tokyo (JP); Yoji Kitajima, Tokyo (JP); Kazuya Watanabe, Iwate (JP); Takefumi Shimoyama, Iwate (JP); Toshikazu Ishii, Iwate (JP); Shoko Komukai, Iwate (JP)

(21) Appl. No.: 12/998,383

(22) PCT Filed: Oct. 15, 2008
(86) PCT No.: PCT/JP2008/068617

§ 371 Date: Sep. 19, 2011

(51) Int. Cl. H01M 8/16; H01M 8/04; H01M 8/10

(52) U.S. Cl. 429/2

(57) ABSTRACT

[PROBLEMS] To provide a microbial fuel cell whose parts can be replaced without lowering the energy recovery efficiency and a membrane cassette for microbial fuel cells. [MEANS FOR SOLVING PROBLEMS] A negative electrode (10) supporting anaerobic microorganisms (11) is immersed in an organic substrate (S). A positive electrode (15) sealed together with an electrolyte (D) in a closed hollow cassette (20) having an outer shell (25) at least a part of which is formed of an ion-permeable membrane (21), an inlet (22), and an outlet (23) or connected to the inner side of an ion-permeable membrane (21) is inserted into the organic substrate (S). While oxygen (O) is supplied into the cassette (20) through the inlet (22) and the outlet (23), electricity is taken out through a circuit (18) electrically interconnecting the negative and positive electrodes (10, 15). Preferably, the outer shell (25) of the closed hollow cassette (20) is a hollow outer shell frame (25) having an opening (26) which is closed by stretching an ion-permeable membrane (21), an inlet (22), and an outlet (23), and the ion-permeable membrane (21) is a membrane/electrode assembly (MEA) formed integrally with the positive electrode (15).

### TECHNICAL FIELD

This invention relates to microbial fuel cell and cassette type diaphragm therefor, more specifically microbial fuel cell for generating electricity from liquid containing organic substances by using anaerobic microorganisms and cassette type diaphragm for such microbial fuel cell.

### BACKGROUND ART

As disclosed in the under-mentioned Patent Documents Nos. 1 and 2, a energy generating or recovering system from organic substances, e.g. organic waste or organic drainage, by using anaerobic microorganisms has been developed, in which the organic substances are converted into biogas such as methane or hydrogen by means of anaerobic microorganisms such as methane fermentation microorganisms or micro-flora, and then the biogas is converted into energy power such as electrical energy by means of turbines or fuel cells. For example, the Patent Document No. 1 discloses a two-step energy recovering system from the organic substances that comprising (i) first step for feeding the organic substances into an anaerobic bioreactor retaining microorganisms so as to convert them into biogas, and (ii) second step for feeding the biogas into a fuel cell so as to convert it into electricity. However, such two-step energy recovering system causes loss of energy in the first step resulting in low energy-recovery efficiency as a whole (normally lower than 40%).

In comparison, as disclosed in the under-mentioned Patent Documents Nos. 3 and 4, new technology is being developed that eliminates a conversion step to biogas, i.e. first step in the energy recovering system of Patent Documents No. 1. It is called Microbial Fuel Cell (it is sometimes referred to as MFC, hereinafter) that directly recovers electrical energy from organic substances by using anaerobic microorganisms through one step. FIGS. 12(A) and 12(B) illustrate two microbial fuel cells 50 and 60 disclosed in the Patent Documents Nos. 3 and 4, respectively. Theory of the microbial fuel cell is briefly explained below with reference to these figures.

FIG. 12(A) illustrates a microbial fuel cell 50 comprising a working electrode (anode) 51 made of electrically conductive porous material such as carbon fiber for retaining microorganisms, a counter electrode (cathode) 52 for contacting with oxidizer material, and an ion permeable diaphragm 53 placed between the two electrodes, in which the working electrode 51 is supplied with an liquid or gas containing electrolyte, e.g. organic substances, 57 and the counter electrode 52 is supplied with air or oxygen 58. A power collection sheets 55, 55 are connected between the working electrode 51 and the counter electrode 52 via divider plates 54, 54 and form a closed circuit by connecting each other with an external electric circuit (not exhibited). Hydrogen ion (H⁺) and electron (e⁻) are generated at the working electrode 51, and the hydrogen ion so generated moves to the side of the counter electrode 52 through the ion permeable diaphragm 53 and the electron moves to the side of the counter electrode 52 through power collection sheet 55 and external circuit. Hydrogen ion and electron so moved from the working electrode 51 combine with oxygen (O₂) and are consumed by forming water (H₂O). At this phase, electrical energy flowing into the closed circuit can be collected or recovered.

FIG. 12(B) illustrates another microbial fuel cell 60 of three-level nesting structure including inner tubular anode 61, outer tubular cathode 63, and ion permeable tubular diaphragm 62 between the two electrodes 61 and 63, in which the inside hollow of the tubular anode 61 is supplied with a solution or suspension 64 containing anaerobic microorganisms and organic substances, and the outer surface of the tubular cathode 63 is brought into contact with air or oxygen 65. Similarly with the fuel sell depicted in FIG. 12(A), hydrogen ion (H⁺) and electron (e⁻) are generated at the tubular anode 61, and the hydrogen ion so generated moves to the side of the tubular cathode 63 through the ion permeable diaphragm 62, and then a potential difference occurs between the anode 61 and the cathode 63. A closed circuit is formed when the anode 61 and the cathode 63 are connected with a conductive wire 66, and electrical energy flowing through the conductive wire can be collected or recovered.

Both of the microbial fuel cells 50 and 60 in FIG. 12 generate electrical energy directly from the organic substances through microbial catalytic processes, i.e. metabolic or biochemical conversion processes, without a conversion step to biogas, and hence improved high energy-recovery efficiency can be obtained compared with that of the prior two-step energy recovering system. Of course this technology of microbial fuel cell can be applied to ancillary facilities in wastewater treatment and organic waste treatment plants, similarly with the two-step energy recovering system. In FIG. 12, electrons are generated from the organic substances at the anode 51, 61 and transferred eventually to the anode 51, 61 via an electron transport system of microorganisms, and a mediator may be added to microorganisms for the purpose of accelerating electron transport within the microorganisms.
[Patent Document No. 1]
Japanese Patent Laying-open Publication No. 2000-167523
[Patent Document No. 2]
Japanese Patent Laying-open Publication No. 2002-280054
[Patent Document No. 3]
Japanese Patent Laying-open Publication No. 2006-159112
[Patent Document No. 4]
Japanese Patent Laying-open Publication No. 2004-342412

### SUMMARY OF INVENTION

### Technical Problem

In the microbial fuel cell as disclosed in FIG. 12, microorganisms that decompose the organic substance and generate electrical energy, i.e. anaerobic microorganisms or mixed micro-flora responsible for electrical energy generation, inhabit and increase mostly on or around the anodes 51, 61. However, depending on operating conditions, certain type of microorganisms (such as aerobic microorganisms) may increase around the diaphragm 53, 62 and/or the cathodes 52, 63 that may result in decrease of power of energy generation of the diaphragm 53, 62 and/or the cathodes 52, 63. Further, it is reported that a prior art fuel cells tend to cause degradation of the diaphragm or the cathode by radical actions after a long period of operation. Therefore, periodical exchange of the degraded diaphragm and/or cathode is required in order to maintain high energy-recovery efficiency for a long period of time.

In the microbial fuel cell as disclosed in FIG. 12, however, the diaphragm 53, 62 and the cathodes 52, 63 are structural members of the cell and indispensable for maintaining airtight condition of the anodes 51, 61, and hence the diaphragm 53, 62 and/or the cathode 52, 63 can not be exchanged without dismantling the fuel cell and terminating airtight condition of the anode 51, 61. Microorganisms on the anode for electrical energy generation are mostly anaerobic and vulnerable to oxygen, and their bioactivity and energy-recovery efficiency will be significantly damaged if exposed to air. Therefore, when airtight condition of the anode 51, 61 is terminated for exchanging the degraded diaphragm 53, 62 and/or cathode 52, 63, microorganisms on the anodes 51, 61 are exposed and damaged by air, resulting in decrease of energy-recovery efficiency during a few days or few weeks before activities and energy-recovery efficiency of microorganism are restored (see the Experimental Example 2 described below).

In laboratory works, the microbial fuel cell may be taken to an anaerobic incubator for being dismantled and exchanging the degraded components under oxygen free conditions. However, in cases the use of anaerobic incubator is impractical or impossible for some reason such as size, shape or installation condition of the cell, the microbial fuel cell have to be dismantled and exchanged in air at the risk of damage in biological activities of microorganisms. Even the large-sized microbial fuel cell for commercial use is infeasible as yet, it is impractical or impossible to prepare anaerobic incubators for such large-sized microbial fuel cell for exchanging the components in commercial works. For promoting commercial production of microbial fuel cell, it is necessary to develop a new technology for exchanging the degraded components of the microbial fuel cell without loss of energy-recovery efficiency.

It is therefore an object of this invention to provide microbial fuel cell and cassette type diaphragm therefor that could exchange the degraded component without decreasing energy-recovery efficiency thereof.

### Solution to Problem

Referring to FIG. 1 and FIG. 2, the first aspect of the present invention provides a microbial fuel cell (1) comprising an anode (10) being adapted to be dipped in a liquid containing organic substances (S) while holding anaerobic microorganisms (11), a cathode (15) being adapted to be inserted into the liquid (S), wherein the cathode (15) is either enclosed with electrolyte (D) in an airtight hollow cassette (20) having inlet and outlet holes (22, 23) and outer shell 25 (refer to FIG. 3(B) and FIG. 4(G)) of which at least a part is formed with ion permeable diaphragm (21) (refer to FIG. 5) or combined with inner surface of the diaphragm (21) of the cassette (20) (refer to FIG. 3(B)), and an electric circuit (18) being connected with the anode (10) and cathode (15), whereby electricity is generated and collected via the circuit (18) by feeding the cassette (20) with oxygen through the holes (22, 23).

Preferably, as shown in FIG. 3(B), the airtight hollow cassette (20) includes a hollow shell frame (25) having inlet and outlet holes (22, 23) and window (26) sealable by the ion permeable diaphragm (21). The ion permeable diaphragm (21) may be a Membrane-Electrode Assembly (it is sometimes referred to as MEA, hereinafter) formed integral with the cathode (15). Alternatively, as shown in FIG. 4(G), the cathode (15a) may be formed breathable, and the airtight hollow cassette (20) may be formed with ion permeable diaphragm (21) coating on whole surface of the cathode (15a) and air-pipe (22, 23) with micro-hole (22a, 23a) connecting to the cathode (15a).

More preferably, as shown in FIG. 1 and FIG. 2, the fuel cell (1) further comprising an anaerobic electrolysis tank (2) having inside space (3) for storing the liquid containing organic substances (S) and retaining the anode (10) while dipping in the liquid (S), closable slot (6) for inserting the airtight hollow cassette (20) into the liquid (S) stored in the inside space (3), and gas feeder (7) for injecting inert gas (G) into the inside space (3) when the slot (6) is open. As shown in FIG. 3(A), the airtight hollow cassette (20) may include a cap (29) for covering the slot (6) of the anaerobic electrolysis tank (2).

Referring to FIG. 3, the second aspect of the present invention provides a cassette type diaphragm (19) for microbial fuel cell (1) having an anode (10) being adapted to be dipped in a liquid containing organic substances (S) while holding anaerobic microorganisms (11), a cathode (15) being adapted to be brought into contact with oxygen and a diaphragm (21) being located between the anode (10) and cathode (15), the cassette type diaphragm (19) comprising an airtight hollow cassette (20) having inlet and outlet holes (22, 23) and outer shell 25 (refer to FIG. 3(B)) of which at least a part is formed with ion permeable diaphragm (21). Preferably, the airtight hollow cassette (20) includes a hollow shell frame (25) having inlet and outlet holes (22, 23) and window (26) sealable by the ion permeable diaphragm (21). The ion permeable diaphragm (21) may be a Membrane-Electrode Assembly (MEA) formed integral with the cathode (15).

### Advantageous Effects of Invention

With the present invention, the anode (10) is dipped in the liquid containing organic substances (S) while holding anaerobic microorganisms (11), and the cathode (15) is inserted into the liquid (S), wherein the cathode (15) is either enclosed with electrolyte (D) in the airtight hollow cassette (20) having inlet and outlet holes (22, 23) and outer shell 25 of which at least a part is formed with ion permeable diaphragm (21) or combined with inner surface of the diaphragm (21) of the cassette (20), and electricity is generated and collected via the electric circuit (18) being connected with the anode (10) and cathode (15) by feeding the cassette (20) with oxygen through the holes (22, 23). And hence, the following outstanding effects can be achieved as a result.

1) As the cathode (15) is enclosed in or combined with inner surface of the airtight hollow cassette (20), the diaphragm (21) and/or the cathode (15) could easily be exchanged by simply plugging in or pulling out of the cassette (20) while keeping the anode (10) being dipped in the liquid containing organic substances (S).
2) Anode (10) can be kept immersed in the liquid containing organic substances (S) while exchanging the airtight hollow cassette (20), damage of anaerobic microorganisms (11) (i.e. extinction or loss of activity of anaerobic microorganisms) on the anode (10) is minimized.
3) In case the anaerobic electrolysis tank (2) having inside space (3) for storing the liquid containing organic substances (S) and retaining the anode (10) while dipping in the liquid (S), closable slot (6) for inserting the airtight hollow cassette (20) into the liquid (S), and gas feeder (7) for injecting inert gas (G) is provided, and the inert gas (G) is injected into the inside space (3) while the slot (6) is open for exchanging the cassette (20), damage of anaerobic microorganism (11) on the anode (10) is further decreased while exchanging of the cassette (20).
4) New cultivation of microorganism after exchange of diaphragm (21) and/or cathode (15) becomes unnecessary and rated electric-generating capacity is resumed as soon as the change completed, by which efficiency degradation can be avoided.
5) The present invention can be applied to a large-sized microbial fuel cell for which an anaerobic incubator is impractical or impossible, so that commercial production of the large-sized microbial fuel cell will be developed or promoted by the present invention.

### DESCRIPTION OF EMBODIMENTS

FIG. 1 shows an embodiment of a microbial fuel cell 1 of the present invention using an anaerobic electrolysis tank 2 and at least one cassette type diaphragm 19. FIG. 2 shows a block diagram of the microbial fuel cell depicted in FIG. 1. In FIG. 1, the anaerobic electrolysis tank 2 includes an inside space 3 that can be airtight by shutting an tank lid 8 for storing a liquid containing organic substances S, i.e. fuel for conversion to energy in the present invention. The tank 2 may retain an anode 10 in the inside space 3 while dipping it in the liquid S. The anode 10 in the space 3 may be an immobilized bed for habitation of anaerobic microorganism 11 in the liquid containing organic substances S that may be an organic drainage or organic waste such as slurry of garbage. The liquid containing organic substances S may flow into the inside space 3 of the electrolysis tank 2 through entrance 4 and tube 4a, and stay awhile in the space 3 while contacting with anode 10 for decomposition of organic substances, and discharge out of the tank 2 through exit 5 and tube 5a.

In FIGS. 1 and 2, the electrolysis tank 2 or the tank lid 8 is equipped with one or more cassette slot 6 where the cassette type diaphragm 19 is inserted or plugged. The cassette type diaphragm 19 may include an airtight hollow cassette 20 having an outer shell 25 of which at least a part is formed with ion permeable diaphragm 21, and a cathode 15 being either enclosed in the cassette 20 or combined with inner surface of the cassette 20. In preferred embodiment, the cassette type diaphragm 19 are inserted or plugged into the tank 2 so as to face closely to the anode 10 but not in contact with each other, in which the ion permeable diaphragm 21 creates outer facing surface of the cassette 19 against the anode 10. As shown in FIGS. 1 and 2, the anode 10 may include a lead wire 12 drawn out of the electrolysis tank 2, and the cathode 15 in the cassette 19 may include lead wire 16 drawn out of the tank 2, and the anode wire 12 and the cathode wire 16 may be so connected by way of an external electric circuit 18 as to constitute the microbial fuel cell 1.

Please note that the electrolysis tank 2 is not indispensable with the present the microbial fuel cell 1 on condition that the microbial fuel cell 1 includes at least one anode 10 for holding anaerobic microorganism 11 and at least one cassette type diaphragm 19 for enclosing or combining the cathode 15 within. Further, the prior art anaerobic bioreactor as disclosed in Patent Documents Nos. 1 and 2 may be used for the microbial fuel cell 1 of the present invention, in which the immobilized beds for microorganism habitation in the bioreactor may be replaced by the anode 10 or may be used as anode 10 of the present invention when they are made of conductive materials such as carbon fibers.

FIG. 3(C) shows an embodiment of anode 10 made of electrically conductive materials suitable for holding anaerobic microorganism 11, such as woven or non-woven fabric made of carbon fibers, and being connected with the anode wire 10. The anode 10 made of carbon fiber may have a lot of pores suitable for adhesion and habitation of anaerobic microorganisms without falling off. Anaerobic microorganism 11, i.e. anaerobic microorganism or mixed micro-flora responsible for electrical energy generation, does not need any artificial incubation and will gradually increase on such anode 10 so long as the anode 10 is dipped in the liquid containing organic substances S. Of course, such anaerobic microorganism or mixed micro-flora for electrical energy generation may be incubated in a laboratory system and adhered afterward on the anode 10. Mediator may be added to anaerobic microorganism 11, if necessary. Though the anode 10 is formed in flat plate in FIG. 3(C), the anode 10 made of carbon fibers may be formed in various shapes according to usage, e.g. in cylindrical shape as depicted in FIG. 12(B).

FIG. 3(A) shows an embodiment of cassette type diaphragm 19 including airtight hollow cassette 20 in which the cathode 15 is enclosed or combined. FIG. 3(B) shows an exploded diagram of the including airtight hollow cassette 20 comprising a hollow shell frame 25 having inlet hole 22, outlet hole 23 and window 26 (refer also to FIGS. 3(D) and 3(F)), a pair of ion permeable diaphragms 21, 21 for sealing the window 26 of the shell frame 25, and a pair of diaphragm fixers 28, 28 for fixing the diaphragms 21, 21 on the shell frame 25. In FIG. 3, the shell frame 25 has a pair of windows 26, 26 for creating a tunnel passing through it, and the diaphragms 21, 21 are respectively stretched on entrance side windows 26 and exit side windows 26 of the tunnel for sealing them, and the diaphragm fixers 28, 28 are respectively put and pressed to the entrance side diaphragm 21 and the exit side diaphragm 21 for fixing and adhering them around the window 26 on the frame 25 so as to form the cassette 20 with airtight hollow 27 (refer also to FIG. 3(E)). Please note the airtight hollow 27 does not necessarily need to penetrate the cassette 20, and one window 26 on the shell frame 25 is sufficient to form the airtight hollow cassette 20 on condition that the window 26 is sealed by the ion permeable diaphragm 21. The diaphragm fixer 28 may be omitted if the diaphragm 21 can be fixed around the window 26 on the frame 25 with adhesive.

The shell frame 25 and the diaphragm fixers 28 of the airtight hollow cassette 20 may be made of plastics such as vinyl chloride, acrylic, polycarbonate, fluorine resins etc, or metallic materials such as iron, stainless steel etc. In preferred embodiment, the shell frame 25 and the diaphragm fixers 28 have a corrosion-proof coating so as to extend their life in the liquid containing organic substances S, when they are made of metallic materials. In FIG. 3, the diaphragm fixer 28 is located on outside surface of the ion permeable diaphragm 21 so that it has a function to prevent the diaphragm 21 from making contact with the anode 10. The diaphragm fixers 28 may be made of insulating material in order to prevent electric contact between the cathode 15 within the cassette 20 and the anode 10 outside the cassette 20 in case the diaphragm 21 is a Membrane-Electrode Assembly (MEA) formed integral with the cathode 15.

The ion permeable diaphragm 21 on the cassette 20 may be made of ion-exchange resin or resin membrane, i.e. a membrane coated with ion-exchange resin, such as “Nafion” (trade name) sold by DuPont Inc. in U.S.A or “Neosepta” (trade name) sold by Tokuyama K.K. in Japan. The diaphragm 21 without ion permeability may be used provided that the diaphragm 21 is water-tight, i.e. having ability for protecting water leakage, at the minimum requirement. It is preferable that the diaphragm 21 has lower oxygen permeability and higher ion permeability, though these properties are generally contradictory. The diaphragm 21 may be made of ceramics.

The airtight hollow cassette 20 may include the cathode 15 being either enclosed within the airtight hollow 27 together with the electrolyte D (e.g. a solution of NaCl or KCl in water) as shown in FIG. 5, or combined with inner surface of the diaphragm 21 as shown in FIG. 3(B). The cathode 15 may be made of electrically conductive metal, carbon fiber or platinum (Pt). Platinum has been found most preferable for the cathode 15 based on the past studies in the art. Though platinum is very expensive, the cathode 15 may be prepared by coating an electrode material such as carbon with Pt powders (or with carbon powders coated with Pt powders) applied on it so as to maximize an effective surface area of Pt and reduce manufacturing costs of the cathode 15. In FIG. 3, the cathode 15 and the ion permeable diaphragm 21 are so shaped into an integral body of MEA (15+21). Namely, the airtight hollow cassette 20 may be formed using MEA (15+21) stretched on the window 26 of the hollow shell frame 25, such as a fluoride based MEA or hydrocarbon based MEA developed in the art of solid polymer type fuel cells. The airtight hollow cassette 20 using MEA (15+21) does not need to enclose the electrolyte D and the cathode 10 within the hollow 27 that resulted in a simple structure of cassette 20 that is called “air-cathode” in the art.

The inlet hole 22 and outlet hole 23 are placed in the airtight hollow cassette 20 for supplying oxygen or air within the hollow 27 to connect with cathode 15. In case of FIG. 2 where the cassette 20 is made of air-cathode MEA (15+21), inlet 22 and outlet 23 may be used for filling in and discharging from the hollow 27 with oxygen O (or air) supplied from gas container 31. As shown in FIG. 3(D), the inlet hole 22 may be connected with an extender tube or hose 24 for supplying oxygen O to the bottom within the hollow 27, and the outlet hold 23 may be arranged at the top of the hollow 27 for making oxygen distribution uniform throughout the hollow 27 and maintaining efficient contact between oxygen and the cathode 15. In case of FIG. 5 where the cathode 15 and the electrolyte D are enclosed within the cassette 20, oxygen or air may be supplied in a similar manner described above using fine extender tube 24 stationed along a nook or corner in the hollow 27 to avoid collision between the extender tube 24 and the cathode 15. The inlet hole 22 and outlet hole 23 may be formed as a inside-tunnel held through and extending from the top to the bottom of the shell frame 25 as shown in FIG. 3(G) without regard to difficulty of processing such inside-tunnel.

As depicted in FIGS. 1, 2 and 3, the cathode wire 16 connected to the cathode 15 within the cassette 20 may be pulled out of the cassette 20 via either one of the inlet hole 22 or the outlet hole 23, but by no means exclusively, and the cassette 20 and its outer frame 25 may be of a rectangular-box in shape, although shapes of the cassette 20 and its frame 25 are selected optionally depend on shapes of the electrolysis tank 2 and the anode 10. The cassette may be in a cylindrical form which surface is formed fully or partially with the ion permeable diaphragm 21, and the anode 10 may be in a tubular form as depicted in FIG. 12(B), and the cylindrical cassette 20 may be fitted or nested into the inside hollow of the tubular anode 10 so as to make a microbial fuel cell 1 of nesting structure.

FIG. 4(G) shows another embodiment of airtight hollow cassette 20 without such hollow shell frame 25 as shown in FIG. 3, comprising a breathable cathode 15a that allows air to pass thorough it, an ion permeable diaphragms 21 coating on whole surface of the breathable cathode 15a, and a pair of air-pipes 22, 23 with micro-holes 22a, 23a connecting to the breathable cathode 15a. FIGS. 4(A) to 4(F) show a manufacturing process of the cassette 20 of FIG. 4(G), in which a cathode 15a is formed or molded using air-permeable material (see FIG. 4(A)) and connected with a cathode wire 16 (see FIG. 4(B)), and further connected with an air-pipe 22 with micro-holes 22a along the right-hand edge and an air-pipe 33 with micro-holes 33a along the left-hand edge (see FIG. 4(C)), and then coated with electric conductive material like platinum (Pt) powders over its entire surface (see FIG. 4(D)). The breathable cathode 15a so formed may be dipped or immersed into ion permeable resin solution 30 so as to apply the ion permeable diaphragm 21 on its whole surface (see FIG. 4(E)), and then the applied ion permeable diaphragm 21 is solidified, polymerized and dried to form an outer shell 25 of the cassette 20 (see FIG. 4(F)). The step of coating with Pt powders (FIG. 4(D)) may be omitted if Pt powders are dissolved or suspended into the ion permeable resin solution 30 and applied on surface of the cathode 15a with resin solution 30 in the application step (FIG. 4(E)) so as to form the breathable cathode 15a which surface wholly coated with the ion permeable diaphragms 21 promptly. The cassette 20 may be a plate-type in shape as shown in FIG. 4, rod-type or tube-type, although shapes of the cassette 20 is selected optionally depend on shapes of the breathable cathode 15a.

Referring to FIGS. 1 and 2, the operation of the microbial fuel cell 1 will be described as follows. The anaerobic electrolysis tank 2 is filled with liquid containing organic substance S at the beginning so that the anode 10 is dipped in the liquid S, and the cassette type diaphragm 19, i.e. airtight hollow cassette 20, in which the cathode 15 is enclosed or combined is inserted into the liquid S through the slot 6 of the tank 2 so as to close or cover the slot 6 with covering cap 29 of the cassette type diaphragm 19, and then the cassette type diaphragm 19 is supplied with oxygen O through inlet and output holes 22, 23. The airtight hollow cassette 20 may have an integrated covering cap 29 for closing the slot 6 as shown in FIGS. 1, 2 and 3, which cap 29 is designed to locate the cassette 20 at the designated place within the tank 2 when it covers the slot 6 of the tank 2. As previously described by referring to FIG. 12, the anode 10 generates hydrogen ion (H⁺) and electron (e⁻) while dipping in the liquid containing organic substance S. The hydrogen ion (H⁺) so generated moves to inside of the cassette 20 through ion permeable diaphragm 21 and the electron (e⁻) moves to the cathode 16 within the airtight hollow cassette 20 through anode wire 12, external electric circuit 18 and cathode wire 16, and they are combined with oxygen (O₂) at the cathode 16 as to form water (H₂O). At this phase, electrical energy flowing on the external circuit 18 can be collected or recovered.

In the preferred embodiment, the ion permeable diaphragm 21 of cassette 20 and the anode 10 are faced each other as closely as possible so as to make sure of the movement of hydrogen ion (H⁺) generated at the anode 10 to inside of the cassette 20 through ion permeable diaphragm 21. The distance between the cathode 15 and the anode 10 may cause decrease of the efficiency of power generation, i.e. electric energy recovery efficiency, of the microbial fuel cell 1. Please note that FIGS. 1 and 2 illustrate the distance between the ion permeable diaphragm 21 and the anode 10 relatively large for ease of explanation. It is desirable to shorten the distance between the diaphragm 21 and the anode 10 for securing easy travel of hydrogen ion between them, preferably less than 1 cm, more preferably less than 5 mm. It is also desirable to make the area of the diaphragm 21 and the anode 10 facing each other as large as possible, preferably the whole cassette's surface or whole facing surface of cassette against the anode 10 is formed with ion permeable diaphragm 21.

The ion permeable diaphragm 21 of cassette 20 and the anode 10 are allowed to come into contact with each other in case of FIG. 5 where electrolyte D is enclosed with the cathode 15 in the airtight hollow cassette 20 and intervenes between the cathode 15 and the ion permeable diaphragm 21, or in case of FIG. 3(B) where the cathode 10 is so combined with inner surface of the diaphragm 21 as to form MEA (15+21) and is not exposed to outside (the side facing against the anode 10) of the diaphragm 21. However, in case of FIG. 3(B) where the cathode 10 combined with inner surface of the diaphragm 21 may be exposed to outside of MEA (15+21), or in case of FIG. 4 where the cathode 15a is formed by applying the ion permeable resin solution 30 dissolving or suspending Pt powders to its surface, the ion permeable diaphragm 21 and the anode 10 are not allowed to come into contact with each other because such contact may cause a short circuit. Namely, when the diaphragm 21 and the anode 10 are to come into contact with each other in such cases of FIG. 3(B) and FIG. 4, electron (e⁻) generated at the anode 10 moves to the cathode 15, 15a directly instead of through the external electric circuit 18, and electric energy recovery efficiency on the external circuit 18 is adversely affected. Therefore, in such cases of FIG. 3(B) and FIG. 4, the diaphragm 21 and the anode 10 have to be kept as closely as possible while avoiding contact with each other. In such case of FIG. 3(B), the diaphragm fixer 28 on outside of the diaphragm 21 may be made of insulating material and used for securing the short distance between the diaphragm 21 and the anode 10 to avoid electrical contact with each other.

FIG. 5 shows a microbial fuel cell 1 comprising a plurality of cells that are electrically connected in parallel by way of external circuit 18. The cells of the microbial fuel cell 1 may be connected in series by the external circuit 18. Further, each cell of the microbial fuel cell 1 may be electrically segregated with each other using barriers 32 as shown in FIG. 6. Such segregation of the cell with barrier 32 is not necessary when electrical conductivity of the liquid containing organic substance S, i.e. fuel for conversion to energy, is not so high as to cause voltage reduction by interference between the cells via the liquid S. However, when electrical conductivity of the liquid S is high enough to cause high electron mobility or leak current between the cells, such segregation of the cell with barrier 32 is effective for taking advantage of connection in series. The cells of the microbial fuel cell 1 may be separated each other by providing each cell with its own entrance 4 and exit 5 for preventing mixture of the liquid S between the cells as shown in FIG. 6, or by designing such appropriate barriers 32 that minimize interference between the cells while allowing mixture of the liquid S within permissible limits. In the latter case, it is not necessity to provide each cell with its own entrance 4 and exit 5. The cassette 20 and anode 10 of each cell may be arranged in parallel as shown in FIGS. 1, 2 and 5, or may be arranged alternately in a radial pattern around the center of them as shown FIG. 8 when an anaerobic tank with circular section is used.

The airtight hollow cassette 20 inserted into the slot 6 of the anaerobic electrolysis tank 2 may be exchanged easily with a new one by simply pulling out of the slot 6 when degraded, depending on the degree of degradation of ion permeable diaphragm 21 and/or cathode 15 within. Further, the cassette 20 may be exchanged while keeping the anode 10 being dipped or immersed in the liquid containing organic substances S, damage of anaerobic microorganisms 11, i.e. extinction or loss of activity of anaerobic microorganisms, on the anode 10 is minimized. In the preferred embodiment, a gas feeder 7 is provided for injecting inert gas G, such as nitrogen, into the inside space 3 (e.g. a gas-phase portion of the inside space) of the anaerobic electrolysis tank 2 when the slot 6 is open, as shown in FIGS. 1 and 2, in order to prevent air inflow through the cassette slot 6. By quick exchange of the cassette 20 with inert gas injection into the inside of the tank 2, damage of anaerobic microorganism 11 on the anode 10 is further decreased.

The airtight hollow cassette 20 pulling out of the slot 6 of the anaerobic tank 2, i.e. cassette 20 degraded with microorganism deposition and/or deteriorated chemically in the liquid containing organic substance S, may be cleaned up with washing of the ion permeable diaphragm 21 and/or MEA (15+21) and reused, as with the case practiced in activated sludge process using permeable diaphragm. In FIG. 5 where the cathode 15 and the ion permeable diaphragm 21 are enclosed in the airtight hollow cassette 20, the cathode 15 and the diaphragm 21 may be separated from each other and reused respectively depending on each component's lifetime and/or economic value. For example, when the cassette 20 includes the diaphragm 21 of relatively short lifetime and the cathode 15 using expensive precious metal (e.g. platinum) as shown in FIG. 5, such cassette 20 may be cleaned by exchanging the degraded diaphragm only with a new one, and may be reused more economically than MEA (15+20) as shown in FIG. 3.

### Experimental Example 1

For the purpose of confirming efficacy of the microbial fuel cell 1 and cassette type diaphragm 19 of the present invention, the microbial fuel cell 1 was test-manufactured by using an anaerobic electrolysis tank 2 (capacity of three liters) of circular section as shown in FIG. 8, an anode 10 made of carbon felt (approx 50 mm×200 mm) as shown in FIG. 3(C), and “air-cathode” as shown in FIG. 3(B), namely an airtight hollow cassette 20 comprising a shell frame 25 (approx 50 mm×200 mm) having a pair of windows 26, 26 (cross section approx 40 mm×180 mm) with stretching MEA (15+21) on both sides, in which five anodes 10 and five air-cathode 20 were arranged facing each other in a radial pattern around the center of them as shown FIG. 8. The tank 2 was continuously fed with artificial wastewater S containing organic polymers including starch (fluid containing organic substance S) at the predefined load of COD (1-3 kg/m³/day) for 160 days continuously, and voltage was continuously recorded with resistance unit (load of 2Ω) on the external electric circuit 18 for confirming variation of energy recovery with time in long-term continuous operation. Soil microbe was planted in the wastewater containing organic substance S as anaerobic microorganism 11, i.e. anaerobic microorganism or mixed micro-flora responsible for electrical energy generation. FIG. 9 shows result of this experiment, i.e. a chart of voltage variation with time in 150 days.

FIG. 9 indicates that it takes around 30 days for initial culture of anaerobic microorganism or mixed micro-flora responsible for electrical energy generation and that electrical voltage generated on the external electric circuit 18 gradually increases during this period. The chart also shows that electrical generation enters a stable period in about 30 days, and voltage at electric circuit 18 stays constant at around 350 mV indicating the energy-recovery efficiency continues stably. However, voltage started to drop gradually from around 100 days after the start of experiment and the energy-recovery efficiency decreased as well. One of the reasons of this drop is assumedly attributed to formation of biofilm composed primarily of aerobic microorganism on the surface of MEA (15+21) of the cassette 20. Namely, the ion permeable diaphragm 21, i.e. MEA (15+21) in this experiment, started to degrade in about 100 days after continuous run and need to be replaced in order to maintain the energy-recovery efficiency.

### Experimental Example 2

After 100 days of continuous experiment using the same microbial fuel cell 1 and organic substance S as used in Experimental 1, the microbial fuel cell 1 was disassembled on the 101th day, and exchanged the airtight hollow cassette 20 in the condition that the anode 10 is exposed to air. In this experiment, the tank lid 8 was removed from the anaerobic electrolysis tank 2 by loosing bolts 9 on it (see FIGS. 1 and 2), the five degraded cassettes 20 were pulled out of the each slot 6 while remaining the inside space 3 in the electrolysis tank exposed to air, and then put in the five new cassettes 20 and covered the tank 2 and fastened the bolts 9. Result of this experiment is shown in FIG. 10 indicating that microorganism inhabiting on the anode 10 was damaged during change of the diaphragm 21 under a condition that the anode 10 is exposed to air and voltage recovered at the external electric circuit 18 decreased significantly. It also indicates that it takes another 25 days for initial culture after exchange of the cassette 20.

### Experimental Example 3

Using the same microbial fuel cell 1 and the fluid containing organic substance S as used in Experiment 1, another long-term continuous experimental operation was conducted. On the 101th day of the experiment, the airtight hollow cassettes 20 were exchanged by pulling out of the cassette slot 6 on the anaerobic electrolysis tank 2 without removal of the tank lid 8. Five slots 6 corresponding to each cassette 20 were built on the anaerobic electrolysis tank 2 which were released temporarily in rotation, and each cassette 20 were quickly replaced with new one. The anode 10 was kept in the liquid containing organic substance S for avoiding exposure to air as much as possible. FIG. 11 shows a result of this experiment, i.e. a chart of voltage variation with time in 180 days.

The chart of FIG. 11 shows that, when the cassette 20 is exchanged by using closable slot 6, voltage decreased a bit due probably to the effect of a small amount of air inflow and mixing within the anaerobic electrolysis tank 2, but voltage returns back to the prior level in a few days. It confirms that the microbial fuel cell 1 and airtight hollow cassette 20 of the present invention has efficacy for suppressing decrease of energy-recovery efficiency during exchange of diaphragm 21 and/or the cathode 15. From further experiment of exchanging the cassette 20 by feeding inert gas G to the inside space 3 of the electrolysis tank 2 from gas feeder 7, it was confirmed that voltage decrease appeared on chart shown in FIG. 11 became even smaller. In summary, it was confirmed that the diaphragm 21 and/or the cathode 15 of the microbial fuel cell 1 is exchangeable while stably maintaining energy-recovery efficiency by the present invention.

Thus, the object of this invention, namely the provision of microbial fuel cell and cassette type diaphragm therefor that could exchange the degraded component without decreasing energy-recovery efficiency thereof has been fulfilled.

### Example 1

As explained above, FIGS. 1, 2, 5 and 6 shows the microbial fuel cell 1 comprising an single anaerobic electrolysis tank 2 having inside space 3 for storing the liquid containing organic substances S, an anode 10 being dipped in the inside space 3 of the tank 2 with the liquid S, a cassette type diaphragm 19 (or an airtight hollow cassette 20) being inserted into the liquid S and containing a cathode 15 enclosed or combined within, and an external electric circuit 18 being connected with the anode 10 and cathode 15, and electricity is generated and collected via the external electric circuit 18 by feeding the cassette type diaphragm 19 with oxygen O through its inlet and outlet holes 22, 23. The cassette type diaphragm 19 (or the airtight hollow cassette 20) of the present invention may be applied also to a dual tank system including separate two tanks 2, 42 as shown in FIG. 7, i.e. an anode tank 2 (anaerobic electrolysis tank) in which the anode 10 is dipped and a cathode tank 42 in which the cathode 15 is dipped.

FIG. 7 shows a dual-tank microbial fuel cell 1 comprising an anode tank (anaerobic electrolysis tank) 2 with inside space 3 for storing fluid containing organic substance S while dipping the anode 10 within, a cathode tank 42 with inside space 43 for storing electrolyte D while dipping the airtight hollow cassette 20 containing cathode 15 within, and a circulator 41 including a pump for circulating fluid containing organic substance S in the anode tank 2 to the cassette 20 in the cathode tank 42. The anode 10 may include a lead wire 12 drawn out of the anode tank 2, and the cathode 15 in the cassette 19 may include lead wire 16 drawn out of the cathode tank 42, and the anode wire 12 and the cathode wire 16 may be so connected by way of an external electric circuit 18 as to constitute the dual-tank microbial fuel cell 1. The cathode tank 42 may be supplied with oxygen O or air in electrolyte D through a tube (not illustrated) lying around the bottom of cathode 15 for getting it contact with oxygen or air. Alternatively, the cathode tank 42 may be supplied through inlet 44 and outlet 45 with electrolyte D saturated with oxygen O or air, and the discharged electrolyte D through the outlet 45 may be saturated with oxygen (or air) and return to inlet 44 for circulation.

In FIG. 7, the dual-tank microbial fuel cell 1 is supplied with liquid containing organic substance S thorough the inlet 22 and outlet 23 of the airtight hollow cassette 20 dipped in the cathode tank 42, send hydrogen ion (H⁺) generated at the anode 10 in the anode tank 2 inside the cassette 20 together with the liquid containing organic substance S, and then circulate hydrogen ion (H⁺) in the cassette 20 to the cathode 15 outside the cassette 20 by way of ion permeable diaphragm 21 of cassette 20 and electrolyte D. Electron (e⁻) generated at the anode 10 in the anode tank 2 moves to the cathode 15 in the cathode tank 42 by way of the anode wire 12, the external electric circuit 18 and the cathode wire 16. As previously described, electrical energy flowing on the external circuit 18 can be collected or recovered. Though the cassette 20 and the cathode 15 are arranged separately in FIG. 7, the cassette 20 and the cathode 15 may be shaped into an integral body of MEA by combining the cathode 15 with outer surface of the diaphragm 21 of the cassette 20 forgetting the outer surface of the diaphragm 21 in contact with oxygen (or air). In this case electrolyte D is not necessary to be used.

Though the dual-tank microbial fuel cell 1 may have a disadvantage of making distance between the anode 10 and the cathode 15 longer, resulting in a higher internal resistance in it, the dual-tank microbial fuel cell 1 may have an much advantage of exchanging the airtight hollow cassette 20 in the cathode tank 42 without opening of the anode tank 2 at all. In case either the ion permeable diaphragm 21 or the cathode 15 degrades, the dual-tank microbial fuel cell 1 may be reused by simply exchanging the airtight hollow cassette 20 in the cathode tank 42, resulting in elimination of the chance to damage anaerobic microorganism 11 on the anode 10 by exposure to air, and in resuming prescribed power generation capacity as soon as the exchange is finished. Further, the dual-tank design makes it possible to separate the cathode 15 that uses expensive precious metal (e.g. platinum) from the ion permeable diaphragm 21 of short lifetime, which results in cost-saving for exchanging and reusing of the cassette 20. In the dual-tank microbial fuel cell 1 as shown in FIG. 7 where the anode tank 2 and the cathode tank 42 are separated, the cassette 20 may be put into the electrolysis tank 2, and the electrolyte D in the cathode tank 42 may be supplied to the cassette 21 through the inlet and outlet pipes 22, 23 for circulation.

### BRIEF DESCRIPTION OF THE DRAWINGS

FIG. 1 is a schematic view of an embodiment of microbial fuel cell of this invention.

FIG. 2 is a block diagram of the microbial fuel cell depicted in FIG. 1.

FIG. 3 is a schematic view of an embodiment of cassette type diaphragm of this invention.

FIG. 4 is a schematic view of another embodiment of cassette type diaphragm of this invention.

FIG. 5 is a schematic view of another embodiment of microbial fuel cell of this invention.

FIG. 6 is schematic view of other embodiment of microbial fuel cell of this invention.

FIG. 7 is a schematic view of an embodiment of microbial fuel cell using two electrolysis tanks of this invention.

FIG. 8 is a schematic view of an embodiment of microbial fuel cell using electrolysis tank with circular cross section of this invention.

FIG. 9 is a chart indicating experimental result of long-term continuous operation of microbial fuel cell of this invention.

FIG. 10 is another chart indicating experimental result of long-term continuous operation of microbial fuel cell of this invention.

FIG. 11 is other chart indicating experimental result of long-term continuous operation of microbial fuel cell of this invention.

FIG. 12 is a schematic view of conventional microbial fuel cell.

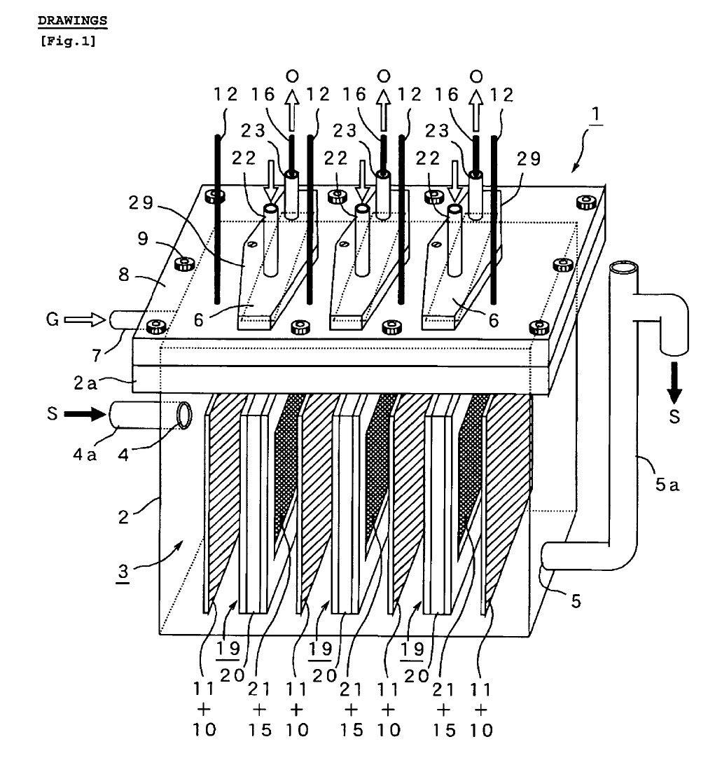

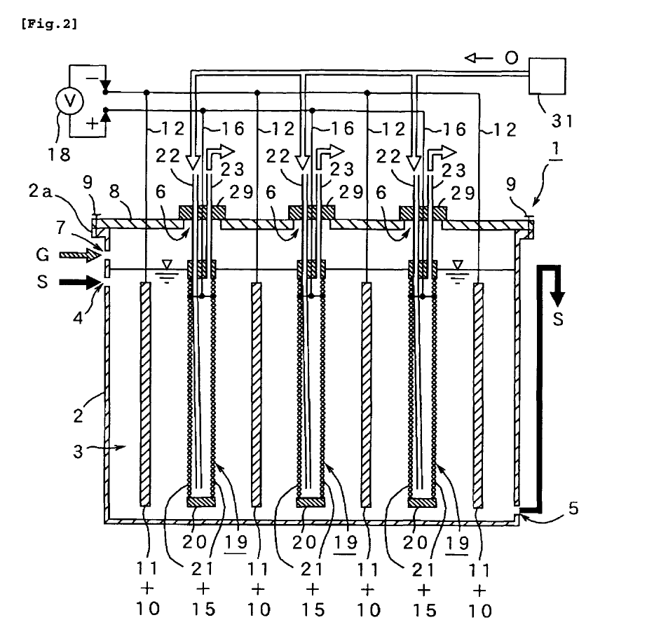

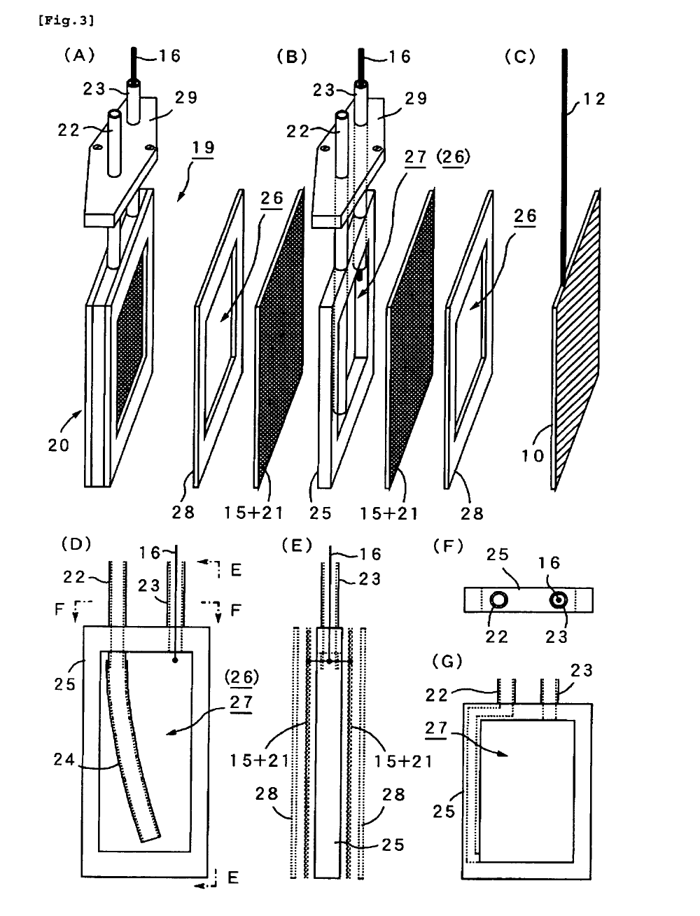

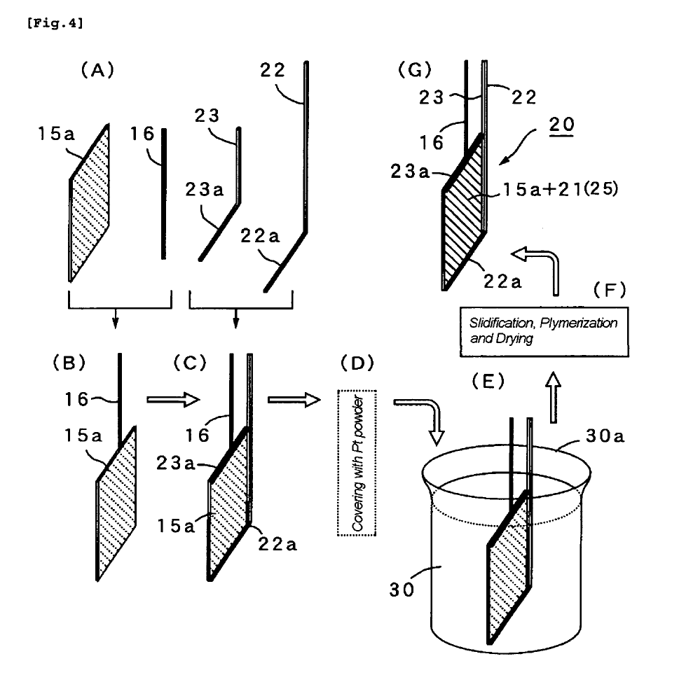

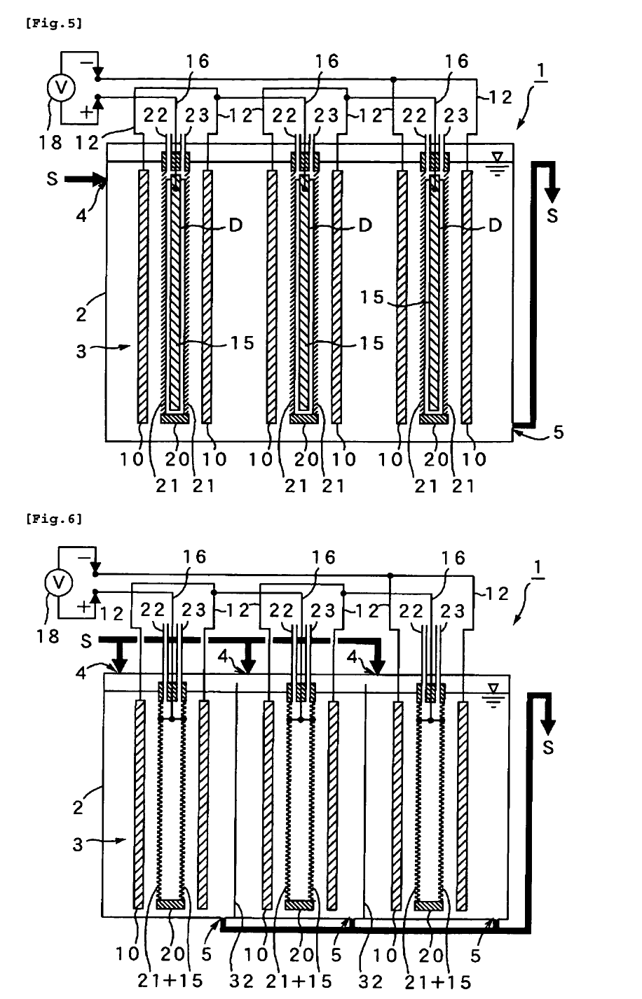

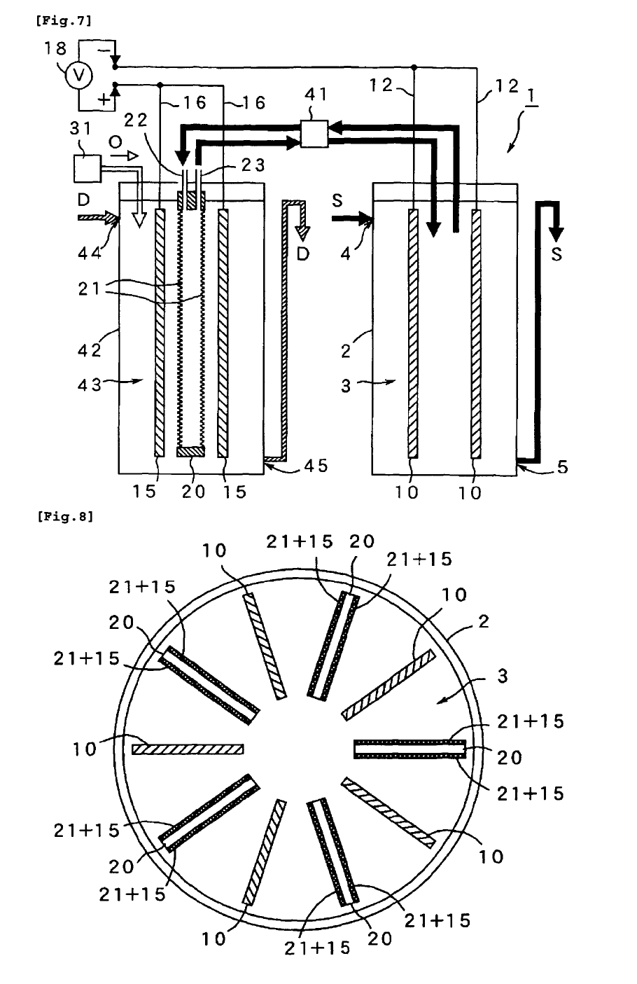

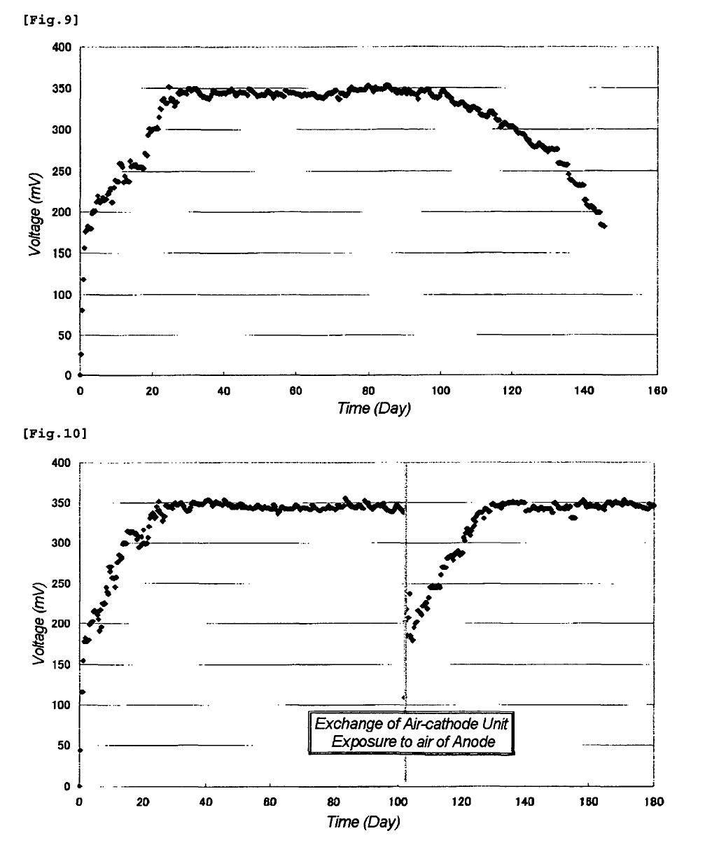

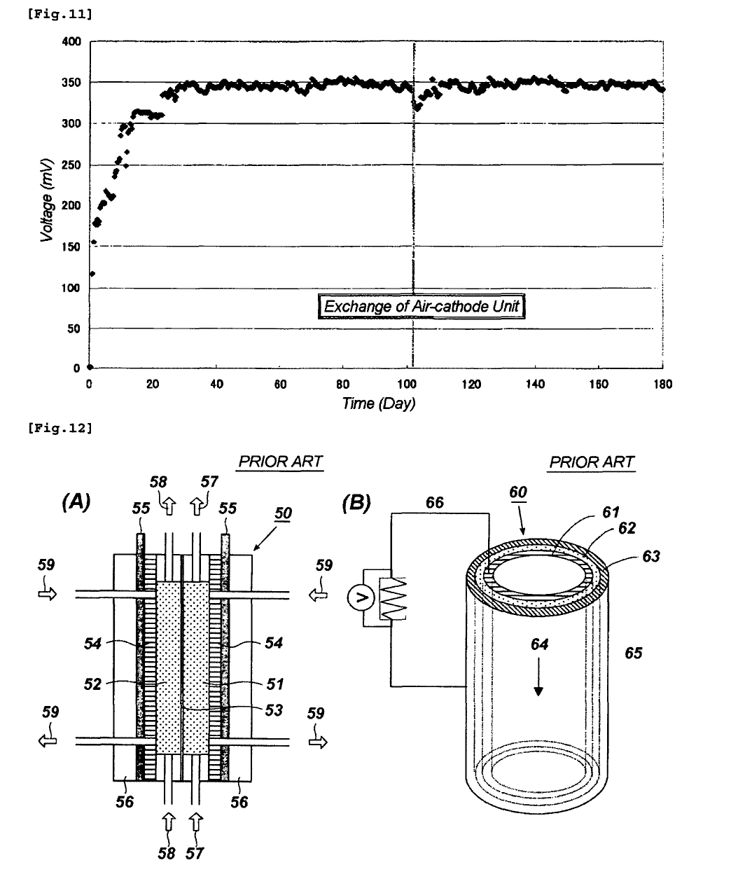

### REFERENCE SIGNS LIST

1 microbial fuel cell
2 anaerobic electrolysis tank (or anode tank)
2a flange
3 inside space
4 entrance
4a entrance tube
5 exit
5a exit tube
6 cassette slot
7 inert gas feeder
8 tank lid
9 bolt
10 anode
11 anaerobic microorganism
12 anode wire
15 cathode
15a breathable cathode
16 cathode wire
18 external electric circuit
19 cassette type diaphragm
20 airtight hollow cassette
21 ion permeable diaphragm
22 inlet hole or air-pipe
22a inlet micro-hole
23 outlet hole or air-pipe
23a outlet micro-hole
24 extender tube or hose
25 outer shell (or hollow outer frame)
26 window
27 hollow
28 diaphragm fixer
29 covering cap
30 ion permeable resin solution
30a container
31 gas container
32 barrier
41 circulator
42 cathode tank
43 inside space
44 electrolyte inlet
45 electrolyte outlet
50 microbial fuel cell
51 working electrode (anode)
52 counter electrode (cathode)
53 ion permeable diaphragm
54 divider plate
55 power collection sheet
56 pressure plate
57 liquid or gas containing electrolyte
58 air (or oxygen)
59 humidifier solution
60 microbial fuel cell
61 anode
62 ion permeable diaphragm
63 cathode
64 organic solution or suspension
65 air or oxygen
66 lead wire
D electrolyte
G inert gas
O oxygen (or air)
S liquid containing organic substances

1. Microbial fuel cell comprising
an anode being adapted to be dipped in a liquid containing organic substances while holding anaerobic microorganisms,
a cathode being adapted to be inserted into said liquid while avoiding contact with said cathode, wherein said cathode is either enclosed with electrolyte in an airtight hollow cassette having inlet and outlet holes and outer shell of which at least a part is formed with ion permeable diaphragm or combined with inner surface of the diaphragm of said cassette, and
an electric circuit being connected with said anode and cathode,
whereby electricity is generated and collected via said circuit by feeding said cassette with oxygen through said holes.

2. Microbial fuel cell according to claim 1, wherein said airtight hollow cassette includes a hollow shell frame having inlet and outlet holes and window sealable by said ion permeable diaphragm.

3. Microbial fuel cell according to claim 1 or claim 2, wherein said ion permeable diaphragm is a membrane-electrode assembly (MEA) formed integral with said cathode.

4. Microbial fuel cell according to claim 1, wherein said cathode is formed breathable, and said airtight hollow cassette is formed with ion permeable diaphragm coating on whole surface of said cathode and air pipe with micro-hole connecting to said cathode.

5. Microbial fuel cell according to any one of claims 1 to 4, wherein the fuel cell further comprising an anaerobic electrolysis tank having inside space for storing the liquid containing organic substances and retaining the anode while dipping in the liquid, closable slot for inserting the airtight hollow cassette into the liquid stored in said inside space, and gas feeder for injecting inert gas into said inside space when said slot is open.

6. Microbial fuel cell according to claim 5, wherein the airtight hollow cassette includes a cap for covering the slot of said anaerobic electrolysis tank.

7. Cassette type diaphragm for microbial fuel cell having an anode being adapted to be dipped in a liquid containing organic substances while holding anaerobic microorganisms, a cathode being adapted to be brought into contact with oxygen and a diaphragm being located between said anode and cathode, said diaphragm comprising an airtight hollow cassette having inlet and outlet holes and outer shell of which at least a part is formed with ion permeable diaphragm, wherein said cassette is either inserted into the liquid containing organic substances while avoiding contact between said anode and cathode or fed with said liquid through said inlet and outlet holes.

8. Cassette type diaphragm for microbial fuel cell according to claim 7, wherein said cathode is either enclosed with electrolyte in said airtight hollow cassette or combined with inner surface of the diaphragm of said cassette, and said cassette is fed with oxygen through said inlet and outlet holes.

9. Cassette type diaphragm for microbial fuel cell according to claim 7, wherein said cathode is either located outside said airtight hollow cassette with electrolyte or combined with outer surface of the diaphragm of said cassette, and said cassette is fed with liquid containing organic substances through said inlet and outlet holes.

10. Cassette type diaphragm for microbial fuel cell according to any one of claims 7 to 9, wherein said airtight hollow cassette includes a hollow shell frame having inlet and outlet holes and window sealable by said ion permeable diaphragm.

11. Cassette type diaphragm for microbial fuel cell according to any one of claims 7 to 10, wherein said ion permeable diaphragm is a membrane-electrode assembly (MEA) formed integral with said cathode.
